(19) United States
(12) Patent Application Publication
(10) Pub. No.: US 2017/0277995 A1
(43) Pub. Date: Sep. 28, 2017

(54) VIBRATION SIGNATURES FOR PROGNOSTICS AND HEALTH MONITORING OF MACHINERY

(71) Applicant: SIKORSKY AIRCRAFT CORPORATION, Stratford, CT (US)

(72) Inventors: Michael J. Giering, Bolton, CT (US); Madhusudana Shashanka, Mountain View, CA (US)

(21) Appl. No.: 15/507,168

(22) PCT Filed: Sep. 24, 2015
(86) PCT No.: PCT/US15/51936

§ 371 Date: Feb. 27, 2017

Related U.S. Application Data
(60) Provisional application No. 62/056,781, filed on Sep. 29, 2014.

(51) Int. Cl. G06N 3/08; G06N 3/10; G06N 3/063; G01H 1/00; G06N 3/04

(52) U.S. Cl. CPC G06N 3/084; G01H 1/003; G06N 3/0445; G06N 3/0481; G06N 3/0472; G06N 3/063; G06N 3/10

(57) ABSTRACT

A system and method for providing health indication of a mechanical system, includes receiving signals indicative of vibration data of the mechanical system; pre-training features in the signals with a model; determining information related to vibration signatures in the signals; associating the vibration signatures with historical vibration data of the mechanical system; and building a multi-layer Deep Neural Network (DNN) from the vibration signatures and the historical vibration data.

### BACKGROUND

The subject matter disclosed herein relates generally to the field of condition based maintenance of machines and to a system and a method of extracting features from signal data to enable better prognostics and health monitoring of machinery.

### DESCRIPTION OF RELATED ART

Vibration monitoring is widely used to monitor a condition of moving machinery, e.g., a gearbox, for condition based maintenance (CBM). CBM comprises a set of maintenance actions based on real-time or near real-time assessments of the condition of, e.g., moving machinery and other systems through vibration signals that can be obtained from embedded sensors, and external tests and measurements, based on current condition indicators. Vibration monitoring techniques can utilize vibration signals from the gearbox to detect, isolate, identify, and predict degraded or faulty performance of the gearbox and its associated machinery. Typical vibration monitoring techniques rely on the domain knowledge of an expert to design appropriate features to characterize vibration data. These features are low dimensional encodings of information carried by the vibration signals. Existing data driven approaches require a predefined transformation of data, for example, Fourier transform, Hilbert-Huang transform, or the like. However, raw vibration signals can have complex statistical distributions and such low dimensional encodings may lose relevant information through characterization. A method of vibration monitoring that does not depend on physics based models and domain expertise would be well received in the art.

### BRIEF SUMMARY

According to an aspect of the invention, a method for providing health indication of a mechanical system, includes receiving, with a processor, signals indicative of vibration data of the mechanical system; pre-training, with the processor, features in the signals with a model; determining, with the processor, information related to vibration signatures in the signals; associating, with the processor, the vibration signatures with historical vibration data of the mechanical system; and building, with the processor, a multi- layer Deep Neural Network (DNN) from the vibration signatures and the historical vibration data.

In addition to one or more of the features described above, or as an alternative, further embodiments could include associating the vibration signatures with known fault types from the historical data.

In addition to one or more of the features described above, or as an alternative, further embodiments could include building an initial two-layer Deep Belief Net (DBN) from the signals.

In addition to one or more of the features described above, or as an alternative, further embodiments could include building a DBN from a stack of Restricted Boltzmann Machines (RBM) comprising hidden variables and observed variables.

In addition to one or more of the features described above, or as an alternative, further embodiments could include determining a non-linearity in the hidden variables using stepped sigmoid units, sigmoid units, or rectified linear units.

In addition to one or more of the features described above, or as an alternative, further embodiments could include building an additional two-layer DBN from the initial two-layer DBN.

In addition to one or more of the features described above, or as an alternative, further embodiments could include associating the vibration signatures with ground truth labels representing known fault types from the historical vibration data.

In addition to one or more of the features described above, or as an alternative, further embodiments could include building the DNN with identical data from the model.

According to another aspect of the invention, a system to provide health indication of a mechanical system, includes a moving machinery associated with the mechanical system; a sensor associated with the moving machinery; a processor; and memory having instructions stored thereon that, when executed by the processor, cause the system to: receive signals indicative of vibration data of the mechanical system; pre-train features in the signals with a model; determine information related to vibration signatures in the signals; associate the vibration signatures with historical vibration data of the mechanical system; and build a multi-layer Deep Neural Network (DNN) from the vibration signatures and the historical vibration data.

In addition to one or more of the features described above, or as an alternative, further embodiments could include a processor that is configured to associate the vibration signatures with known fault types from the historical data.

In addition to one or more of the features described above, or as an alternative, further embodiments could include a processor that is configured to build an initial two-layer Deep Belief Net (DBN) from the signals.

In addition to one or more of the features described above, or as an alternative, further embodiments could include a processor that is configured to build a DBN from a stack of Restricted Boltzmann Machines (RBM) comprising hidden variables and observed variables.

In addition to one or more of the features described above, or as an alternative, further embodiments could include a processor that is configured to determine a non-linearity in the hidden variables using stepped sigmoid units, sigmoid units, or rectified linear units.

In addition to one or more of the features described above, or as an alternative, further embodiments could include a processor is configured to build an additional two-layer DBNs from the initial two-layer DBN.

In addition to one or more of the features described above, or as an alternative, further embodiments could include a processor that is configured to associate the vibration signatures with ground truth labels representing known fault types from the historical vibration data.

Technical function of the embodiments of the invention include prognostics and health management of machinery through extraction of health features in vibration data without utilizing physics based models and domain expertise. The invention uses vibration data to pre-train a model to characterize signatures of features, which are used to backpropagate the features to known condition fault types of machinery in order to predict degraded or faulty performance of machinery.

Other aspects, features, and techniques of the invention will become more apparent from the following description taken in conjunction with the drawings.

### BRIEF DESCRIPTION OF THE SEVERAL VIEWS OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which like elements are numbered alike in the several FIGURES:

FIG. 1 is a perspective view of an example application of a vehicle for use with embodiments of the invention;

FIG. 2 is a schematic view of an exemplary computing system according to an embodiment of the invention;

FIG. 3 is a flowchart of a process for prognostics and health monitoring of an example machinery according to an embodiment of the invention;

FIG. 4 is an example image of vibration signal data for use with embodiments of the invention; and

FIG. 5 is a schematic view of a Deep Neural Network for use with embodiments of the invention.

### DETAILED DESCRIPTION

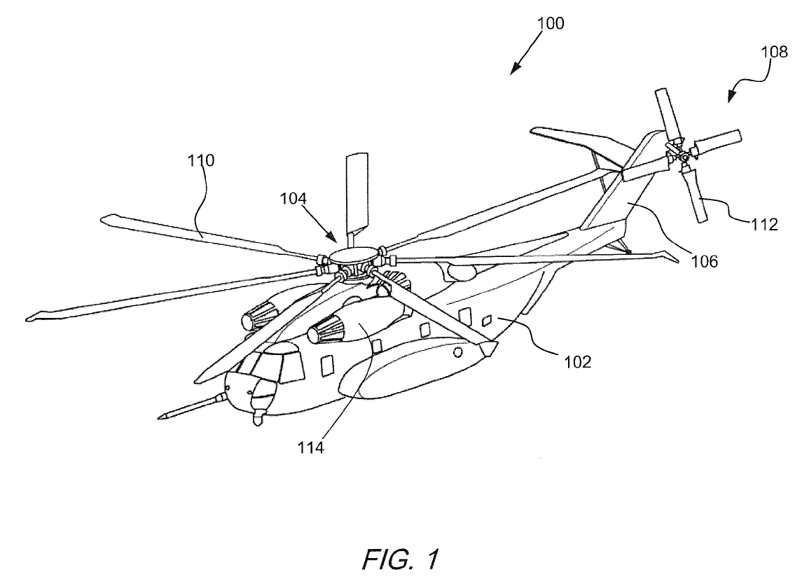

Referring now to the drawings, FIG. 1 illustrates a general perspective view of an exemplary vehicle in the form of a vertical takeoff and landing (VTOL) rotary-wing aircraft 100 for use with embodiments of the invention. In an embodiment, VTOL aircraft 100 includes a computer system that executes an algorithm for prognostics and health monitoring (PHM) of machinery (hereinafter “PHM algorithm”) such as, e.g., a gearbox in aircraft 100. In an embodiment, the computer system may include components that are remote located from aircraft 100 and can receive information through a wired or wireless network in communication with an on-board aircraft computer of aircraft 100. In embodiments, the PHM algorithm utilizes a multi-layer Deep Belief Net (DBN) to generate appropriate signatures or vibremes through an energy based model. The PHM algorithm further provides fine-tuning of the signatures through an additional layer in order to build a Deep Neural Network (DNN) for prognostics and health monitoring of the gearbox. As illustrated, aircraft 100 includes an airframe 102 having a main rotor assembly 104 and an extending tail 106 which mounts an anti-torque system, such as a tail rotor assembly 108. Main rotor assembly 104 and tail rotor assembly 108 are driven to rotate by one or more engines 114 through one or more gearboxes (not shown). The main rotor assembly 104 includes a plurality of rotor blades 110 while tail rotor assembly 108 includes a plurality of rotor blades 112. While prognostics and health monitoring of a gearbox in a particular aircraft 100 is illustrated and described in the disclosed embodiment, monitored machinery in other configurations and/or machines including turbines, motors, chillers, compressors, pumps, and other similar monitored machinery will also benefit from embodiments of the invention.

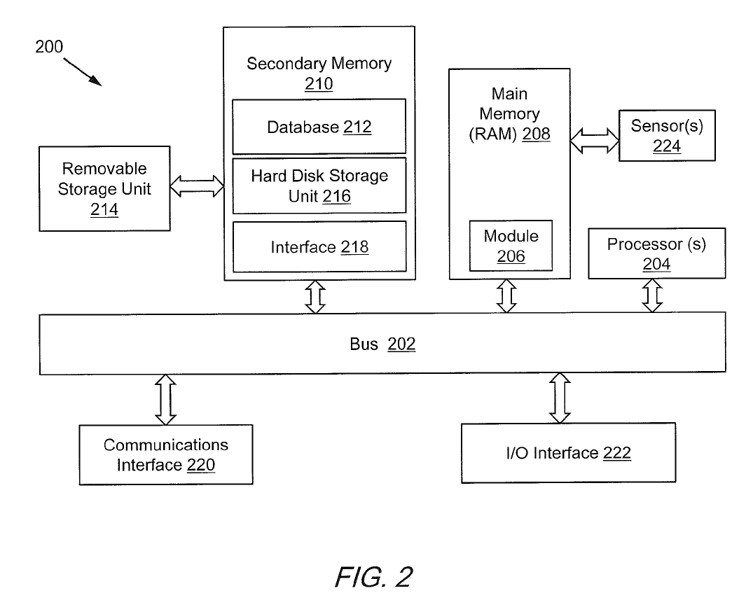

FIG. 2 illustrates a schematic block diagram of a computer system 200 for implementing the embodiments described herein. The invention may be implemented using hardware, software or a combination thereof and may be implemented in a computer system 200. Computer system 200 includes one or more processors, such as processor 204. The processor 204 may be any type of processor (for example, a central processing unit (CPU) or a specialized graphics processing unit (GPU), including a general purpose processor, a digital signal processor, a microcontroller, an application specific integrated circuit, a field programmable gate array, or the like. The processor 204 is connected to a computer system 200 internal communication bus 202. Computer system 200 also includes a main memory 208 such as random access memory (RAM), and may also include a secondary memory 210. The secondary memory 210 may include, for example, one or more databases 212, a hard disk storage unit 216 and one or more removable storage units 214 representing a floppy disk drive, a magnetic tape drive, an optical disk drive, a removable memory chip (such as an EPROM, or PROM) and associated socket, and the like which allow software and data to be transferred from the removable storage unit 214 to computer system 200. The removable storage unit 214 reads from and/or writes to a hard disk storage unit 216 in a well-known manner. As will be appreciated, the removable storage unit 214 includes a computer usable storage medium having stored therein computer software and/or data.

Computer system 200 includes a communications interface 220 connected to the bus 202. Communications interface 220 allows software and data to be transferred between computer system 200 and external devices. Examples of communications interface 220 may include a modem, a network interface (such as an Ethernet card), a communications port, a PCMCIA slot and card, etc. Software and data transferred via communications interface 220 are in the form of signals which may be electronic, electromagnetic, optical, or other signals capable of being received by communications interface 220. These signals are provided to communications interface 218 in secondary memory 210 via a communications path (i.e., channel) and may be implemented using wire or cable, fiber optics, wired, wireless and other communications channels. Also, computer system 200 may receive sensed signals from a plurality of sensors 224 such as, for example accelerometers, for systems and machinery on aircraft 100 (FIG. 1). The sensed signals can include vibration signals in order implement a PHM algorithm for providing prognostics and health monitoring of the same machinery.

The computer system 200 may also include an I/O interface 222, which provides the computer system 200 with access to a display/monitor and the like. In an embodiment, the results and/or pictures of health monitoring based upon the PHM algorithm are reported to the user via the I/O interface 222. Also, a model containing the PHM algorithm for health monitoring is stored as executable instructions in module 206 in main memory 208 and/or hard disk storage unit 216 of secondary memory 210. The PHM algorithm, when executed by processor 204, enables the computer system 200 to perform the features of the invention as discussed herein. The main memory 208 may be loaded with one or more application modules 206 that can be executed by one or more processors 204 with or without a user input through the I/O interface 222 to achieve desired tasks.

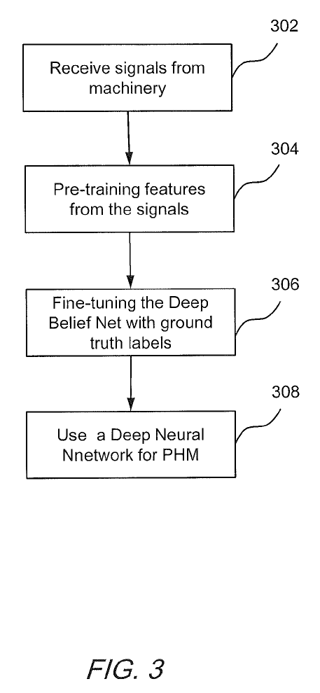

FIG. 3 is a flowchart of a PHM algorithm of an example gearbox in aircraft 100 (FIG. 1) through learning of a DNN according to an embodiment of the invention. The PHM algorithm may be associated with computer system 200 (FIG. 2) that is executed by the processor 204. As such, FIG. 2 is also being referenced in the description of the flowchart of FIG. 3.

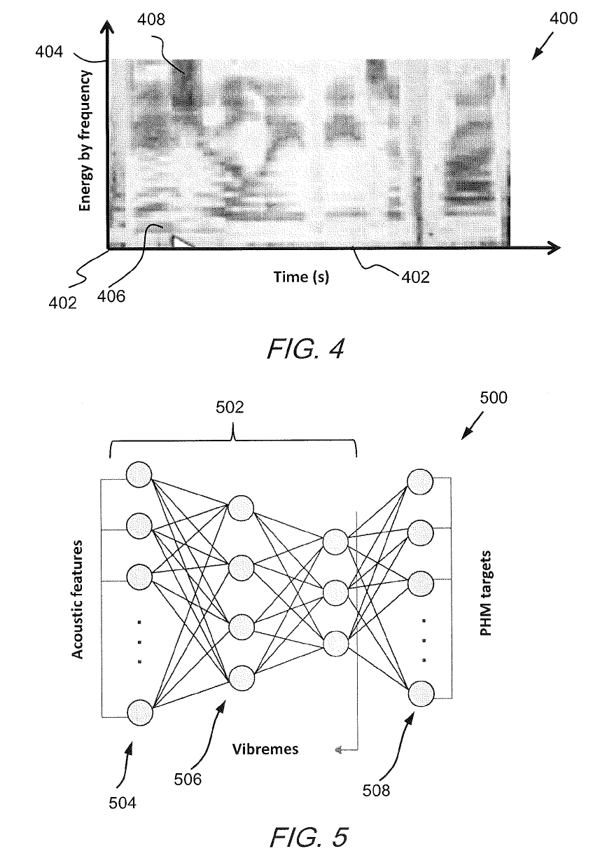

As shown, the exemplary process is initiated in 302 where computer system 200 receives vibration signals from one or more sensors associated with machinery, e.g. a gearbox, in a mechanical system in aircraft 100. For example, the vibration signals can include energy or other data that is received from movement of gears in the mechanical system. FIG. 4 depicts an exemplary chart for a power spectral density (PSD) spectrogram 400 for energy of vibration signals that are received from sensors 224 at different measured frequencies. X-axis 402 represents time and Y-axis 404 represents amount of energy at various frequencies (time and frequency increase traversing away from origin 402). Each column represents a vector for energy, frequency, and time. At an initial time period t1, data point 406 represents vibrational energy at a first frequency for a first vector. At a second time period t2, data point 408 represents a higher vibrational energy at a second frequency. Darker shaded areas in the columns represent more vibrational energy from the gearbox or other machinery associated with sensors 224.

In 304, the vibration signals data are used to pre-train features in the vibration signals using an energy based model. Initially, a multi-layer Deep Belief Net (DBN) is built two-layers at a time using the vibration signals. The multi-layer DBN is built without presenting any labels to the vibration data. The DBN consists of a stack of Restricted Boltzmann Machines (RBM) that forms a single multilayer generative model. An example DBN is illustrated in FIG. 5. The DBN can include many hidden layers such as, for example, layer 506. In order to build the DBN, a RBM is used with hidden variables h and observed variables v, where each joint configuration of observed and hidden variables is assigned an energy E(v,h), and the probabilities p(v,h) are defined by a Boltzmann distribution, according to Equation (1). For example, let v represent a fragment of vibration signal of length T samples. The fragments are obtained by breaking the vibration signal into windows where two consecutive windows can have overlapping points.

$$p ( v , h ) = \frac{1}{z} {e}^{- E ( v , h )} \\ where \text{:} Z = {Σ}_{( v , h )} exp ( - E ( v , h ) ) \qquad ( 1 )$$

In one example, a Gaussian-Bernoulli RBM is used where linear variables are visible and hidden variables are binary; but, in other embodiments, other variants can be used based on the specific application. Hidden units or variables are followed by a non-linearity and can include stepped sigmoid units (SSU) for the hidden variables h. In an embodiment, the SSU can be applied according to the method disclosed in a non-patent literature publication authored by N. Jaitly and G. Hinton entitled “Learning a better representation of speech sound waves using restricted Boltzmann machines,” ICASSP, 2011, which is herein incorporated by reference. In embodiments, sigmoid units, rectified linear units, or the like may be used for the hidden variables h. Parameters are learned using contrastive divergence. Outputs of the RBM are the first-level vibremes or vibration signatures. These vibremes, the inferred states of the hidden units of the first RBM, can be used as training data to train another RBM to capture their dependencies. RBM training can be repeated as many times as desired or required to produce many layers of non-linear feature detectors (i.e., higher level vibremes). The activations or outputs of the hidden units at each RBM encode characteristic features present in the vibration signals to create vibration signatures or vibremes. In 306, the learned parameters are fine-tuned. The parameters are tuned by associating the vibremes (classify or associate the signatures) with ground truth labels (backpropagation) through a DNN. In other embodiments, other classification techniques can be used to associate the signatures to labels.

In an example, fine-tuning is performed by training a DNN on historical vibration data that contains ground truth labels. A ground truth label can include a known fault type that is identified from historical data such as, for example, a health condition indicator (CI). These ground truth labels are not limited to fault types and can correspond to descriptors of other physical conditions of interest that can identify fault types of machinery for PHM. FIG. 5 depicts a DNN 500 with a multi-layer DBN 502 having multiple layers 504, 506 and nodes and synapses.

In this step, a multi-layer neural network is instantiated with the number of layers and number of nodes in each layer being identical to the DBN learned in 304. All the weights in the network are initialized to the parameters learned in the DBN of 304. A DNN can include many hidden layers for prognostics and health monitoring (PHM) using vibration signals. A DNN is a feedforward artificial neural network that has more than one layer of hidden units between its inputs and outputs. Each hidden unit, j, uses the logistic function to map its total input from the layer below, xⱼ, to the scalar state, yⱼ, that it sends to the layer above, according to equations (2) and (3).

$$\begin{matrix}{y}_{j} = \frac{1}{1 + {e}^{- {x}_{j}}} ; & ( 2 ) \\ {x}_{j} = {b}_{j} + Σ {y}_{i} {w}_{ij} & ( 3 )\end{matrix}$$

where bⱼ is the bias of unit j, i is an index over units in the layer below, and wᵢⱼ is the weight to unit j from unit i in the layer below.

In 308, for a final layer 508 (FIG. 5), that contains ground truth labels, the output j converts its total input, xⱼ, into a class probability, pⱼ using the softmax nonlinearity function of equation (4) to predict fault types in the aircraft using the ground truth labels:

$${p}_{j} = \frac{{e}^{{x}_{j}}}{{Σ}_{k} {e}^{{x}_{k}}} \qquad ( 4 )$$

where k is an index over all classes.

Benefits of the invention include a PHM algorithm to learn a DNN method for PHM of machinery without using domain expertise of conventional methods. The PHM algorithm utilizes a deep learning approach including a generative pre-training step and backpropagation in order to predict degraded or faulty performance of the gearbox that accurately determines faults for PHM over prior methods. Additional benefits can include building models where predictive ground truth labels are orders of magnitude less than the large amount of data collected and used in PHM of machinery.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions or equivalent arrangement not hereto described will be apparent to those of ordinary skill in the art without departing from the scope and spirit of the invention. Additionally, while the various embodiments of the invention have been described, it is to be understood that aspects of the invention may include only some of the described embodiments. Accordingly, the invention is not to be seen as limited by the foregoing description, but is only limited by the scope of the appended claims.

1. A method for providing health indication of a mechanical system, comprising:
receiving, with a processor, signals indicative of vibration data of the mechanical system;
pre-training, with the processor, features in the signals with a model;
determining, with the processor, information related to vibration signatures in the signals;
associating, with the processor, the vibration signatures with historical vibration data of the mechanical system; and
building, with the processor, a multi-layer Deep Neural Network (DNN) from the vibration signatures and the historical vibration data.

2. The method of claim 1, wherein the associating of the vibration signatures further comprises associating the vibration signatures with known fault types from the historical data.

3. The method of claim 1, wherein the pre-training further comprises building an initial two-layer Deep Belief Net (DBN) from the signals.

4. The method of claim 3, further comprising building a DBN from a stack of Restricted Boltzmann Machines (RBM) comprising hidden variables and observed variables.

5. The method of claim 4, further comprising determining a non-linearity in the hidden variables using stepped sigmoid units, sigmoid units, or rectified linear units.

6. The method of claim 4, further comprising building an additional two-layer DBN from the initial two-layer DBN.

7. The method of claim 1, further comprising associating the vibration signatures with ground truth labels representing known fault types from the historical vibration data.

8. The method of claim 1, further comprising building the DNN with identical data from the model.

9. A system to provide health indication of a mechanical system, comprising:
a moving machinery associated with the mechanical system;
a sensor associated with the moving machinery;
a processor; and
memory having instructions stored thereon that, when executed by the processor, cause the system to:
receive signals indicative of vibration data of the mechanical system;
pre-train features in the signals with a model;
determine information related to vibration signatures in the signals;
associate the vibration signatures with historical vibration data of the mechanical system; and
build a multi-layer Deep Neural Network (DNN) from the vibration signatures and the historical vibration data.

10. The system of claim 9, wherein the processor is configured to associate the vibration signatures with known fault types from the historical data.

11. The system of claim 9, wherein the processor is configured to build an initial two-layer Deep Belief Net (DBN) from the signals.

12. The system of claim 11, wherein the processor is configured to build a DBN from a stack of Restricted Boltzmann Machines (RBM) comprising hidden variables and observed variables.

13. The system of claim 12, wherein the processor is configured to determine a non-linearity in the hidden variables using stepped sigmoid units, sigmoid units, or rectified linear units.

14. The system of claim 12, wherein the processor is configured to build an additional two-layer DBNs from the initial two-layer DBN.

15. The system of claim 9, wherein the processor is configured to associate the vibration signatures with ground truth labels representing known fault types from the historical vibration data.
